(19) United States
(12) Patent Application Publication
(10) Pub. No.: US 2016/0216751 A1
(43) Pub. Date: Jul. 28, 2016

(54) AUDIO PROCESSING SYSTEM

(71) Applicant: SAMSUNG ELECTRONICS CO., LTD., SUWON-SI (KR)

(72) Inventors: SUN KYU KIM, YONGIN-SI (KR); MIN SOO KIM, HWASEONG-SI (KR); DONG HAN LEE, SEONGNAM-SI (KR)

(21) Appl. No.: 15/003,285

(22) Filed: Jan. 21, 2016

(30) Foreign Application Priority Data
Jan. 22, 2015 (KR) 10-2015-0010327

(51) Int. Cl. G06F 1/32; G06F 3/16

(52) U.S. Cl. CPC G06F 1/3203; G06F 3/162

(57) ABSTRACT

An audio processing system includes a first unit including a central processing unit (CPU) and a top domain. A system memory unit stores decoded audio data and a power management unit is configured to control power supply to the first unit and the system memory unit. An audio sub-system generates a first interrupt signal when an audio buffer, which temporarily stores the audio data, is emptied and determines whether the first unit should exit a low power mode in response to the first interrupt signal.

### CROSS-REFERENCE TO RELATED APPLICATIONS

This application claims priority under 35 U.S.C. §119(a) from Korean Patent Application No. 10-2015-0010327 filed on Jan. 22, 2015, the disclosure of which is hereby incorporated by reference in its entirety.

### BACKGROUND

Embodiments of the inventive concept relate to audio processing systems, and more particularly, to audio processing systems operating with reduced power consumption during audio playback.

In many contemporary electronic devices, multi-channel, multimedia data is compressed using an encoding device. One or more resulting compressed signal(s) may thereafter be communicated to a decoding device or stored in a data storage medium together with certain overhead of spatial information signal(s). Systems that effectively restore compressed audio data (e.g., compressed audio data compatible, for example, with MP3, AAC, or WMA standards) or compressed video data (e.g., compressed video data compatible, for example, with MPEG standards) may provide corresponding analog data and/or digital pulse code modulation data during audio/video playback. However, the power conventionally consumed during playback—that is, the power required to restore compressed multimedia data to a form capable of being output for user perception—is considerable. And in the context of portable (i.e., battery powered) consumer devices, such playback power consumption of compressed multimedia data may be a serious performance limitation.

### SUMMARY

Some embodiments of the inventive concept provide an audio processing system that selectively activates only necessary components during audio playback in order to limit power consumption.

According to some embodiments of the inventive concept, there is provided an audio processing system comprising; a storage domain including a system memory unit, a first unit including a central processing unit (CPU) and a top domain, wherein the CPU decodes audio data stored in the storage domain to generate decoded audio data that is stored in the system memory unit, a power management unit configured to provide at least one power supply signal to the first unit and the system memory unit, and an audio sub-system including an audio buffer that stores decoded audio data received from the system memory unit, a first Direct Memory Access (DMA) unit that moves decoded audio data from the audio buffer to an audio interface, wherein the first DMA unit generates a first interrupt signal when the audio buffer is emptied, and a control logic that determines when the first unit exits a low power mode.

The control logic may include a counter generating a count value, and the first unit exits the low power mode only when the count value reaches a predetermined count value threshold.

The counter may reset the count value in response to the first interrupt signal.

The control logic may generate a power ON signal, and the power management unit enables the system memory unit to exit the low power mode in response to the first interrupt signal and the power ON signal.

The audio sub-system may also include a second DMA unit that moves the decoded audio data from the system memory unit to the audio buffer and generates a second interrupt signal when the audio buffer is filled.

The control logic may generate a power OFF signal, and the power management unit enables the system memory unit to enter the low power mode in response to the second interrupt signal and the power OFF signal.

The power management unit may enable the system memory unit to exit the low power mode only when the first unit has not entered the low power mode regardless of the power OFF signal.

The control logic may also include a management unit that generates a wake-up signal causing the first unit to exit the low power mode when the count value reaches the count value threshold, and a power register that generates the power ON signal enabling the system memory unit to exit the low power mode when the first interrupt signal is generated, and the power OFF signal that enables the system memory unit to enter the low power mode when the second interrupt signal is generated.

According to some embodiments of the inventive concept, there is provided an audio processing system configured to operate in a playback mode, the audio processing system comprising: a storage domain including a system memory unit that stores audio data, and is selectively configured to operate in a low power mode and a normal power mode; a first unit including a central processing unit (CPU) and a top domain, wherein the CPU decode the audio data to generate decoded audio data, and the CPU is selectively configured to operate in the low power mode and the normal power mode; an alive domain including a power management unit that provides at least one power supply signal to the first unit and the system memory unit in response to a user input signal indicating operation of the audio processing system in the playback mode; and an audio sub-system including; an audio buffer that stores decoded audio data, a first Direct Memory Access (DMA) unit that moves decoded audio data from the audio buffer to an audio interface, wherein the first DMA unit generates a first interrupt signal when the audio buffer is emptied, and a control logic that determines when the CPU operates in the low power mode.

According to some embodiments of the inventive concept, there is provided a method of operating an audio processing system, including; emptying decoded audio data from an audio buffer to an audio interface, generating a first interrupt signal and a power ON signal in response to the emptying of the audio buffer, activating a system memory unit storing decoded audio data in response to the power ON signal, incrementing a count value in response to the first interrupt signal, generating a wake-up signal when the count value reaches a count value threshold, activating a Central Processing Unit (CPU) to decode audio data to generate decoded audio data, and storing the decoded audio data in a stream buffer.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a perspective view of an electronic device including an audio processing system according to some embodiments of the inventive concept;

FIG. 2 is a block diagram of an audio processing system according to some embodiments of the inventive concept;

FIG. 3 is a block diagram further illustrating in one example the audio processing system 20 of FIG. 2;

FIG. 4 is a block diagram further illustrating in one example the audio sub-system 400 of FIG. 3;

FIG. 5 is a conceptual diagram illustrating exemplary operation of the audio sub-system of FIG. 4;

FIG. 6 is a block diagram further illustrating in one example the control logic 430 of FIG. 5;

FIG. 7 is a timing diagram further illustrating in one example the operation of the audio processing system 400 of FIG. 2; and

FIG. 8 is a block diagram of an electronic system including an audio processing system according to some embodiments of the inventive concept.

### DETAILED DESCRIPTION

Certain embodiments of the inventive concept will now be described in some additional detail with reference to the accompanying drawings. This invention may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and labels are used to denote like or similar elements and/or features.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, ^{an} _{and} ^{the} are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

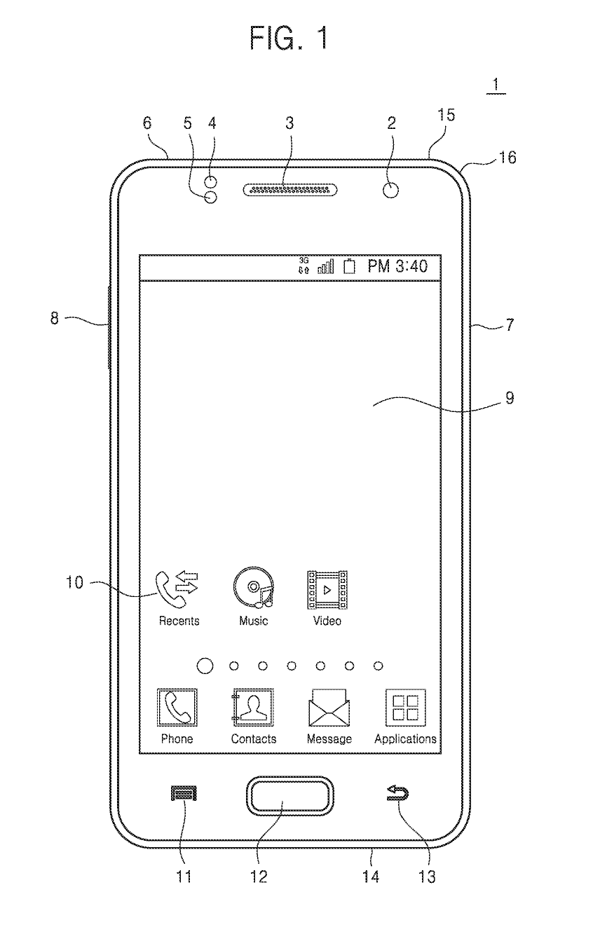

FIG. (FIG.) 1 is a perspective view of an electronic device 1 including an audio processing system according to some embodiments of the inventive concept. The electronic device 1 may be a device, such as an electronic dictionary, a cellular phone, an MP3 player, or a tablet personal computer (PC) capable of “playing” or “playing-back” multimedia data. The electronic device 1 will typically be operated in response to direct user input, but may also be used to communicate with other devices via the Internet or other network systems. FIG. 1 illustrates a cellular phone including a touch screen as an example of the electronic device 1. Thus, for example, the electronic device 1 includes a front camera 2, a speaker 3, a proximity sensor 4, a luminance sensor 5, a universal serial bus (USB) interface 6, a power button 7, a volume button 8, a display and touch screen 9, icons 10, a menu button 11, a home button 12, a back button 13, a microphone 14, an audio output interface 15, and an antenna 16.

The front camera 2 faces in a direction in which the display and touch screen 9 and is used for a video call or video or photo shooting. The speaker 3 may output audio data when a user plays multimedia data by touching the display and touch screen 9 on one of the icons 10 or inputting a signal by speech, talks with another user over a public switched telephone network, or plays an operation sound of the electronic device 1 or a notification sound. The proximity sensor 4 controls on or off of the display and touch screen 9 in order to save power and prevent miss-operation when a user holds the electronic device 1 up to an ear for telephone conversation. The luminance sensor 5 controls the operations of the display and touch screen 9 and the front camera 2 according to the quantity of incident light from the surroundings of the electronic device 1. The USB interface 6 is an input/output interface for data communication with external devices and power supply.

The power button 7 may turn on or off the power of the electronic device 1 or may turn on or off the display and touch screen 9. The volume button 8 may control the audio output of the speaker 3. The icons 10 corresponding to different functions may be displayed on the display and touch screen 9. For instance, a user may touch an icon 10 corresponding to playback of multimedia data.

The menu button 11 may allow a user to browse a menu including icons and settings. The home button 12 may allow a home screen to appear for multi-working mode even while the electronic device 1 is performing a certain operation on the display and touch screen 9. The back button 13 may cancel an operation which is currently being performed by the electronic device 1 and returns a user to a previous screen.

The microphone 14 is an input/output (I/O) interface for voice calls or voice input signals. The audio output interface 15, e.g., an earphone jack, is for audio output of multimedia data which is being played. Although not shown, audio output and microphone input may be interfaced through a device supporting Bluetooth. The antenna 16 is used to receive digital media broadcasting service. The elements of the electronic device 1 may be embodied in various ways realizable to those of ordinary skill in the art.

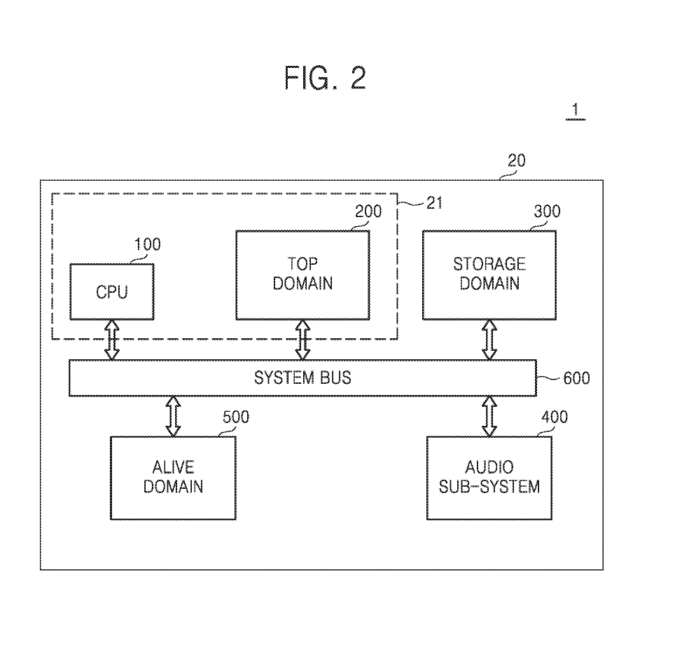

FIG. 2 is a block diagram illustrating an audio processing system 20 according to some embodiments of the inventive concept. Referring to FIGS. 1 and 2, the electronic device 1 may include the audio processing system 20, which may specifically operate during a mode compatible with playing-back audio data. The audio processing system 20 of FIG. 2 generally includes a first unit 21 including a central processing unit (CPU) 100 and a top domain 200, a storage domain 300, an alive domain 500, an audio sub-system 400, and a system bus 600.

Here, the term “domain” refers to one or more circuit blocks (e.g., hardware component(s)) and/or program code-enabled functions (e.g., software components) used to implement a feature or associated functionality within the audio processing system 20. Thus, it may be one or more hardware component(s) and/or software components that enable a particular function or result described hereafter. Exemplary hardware components include a processor running program code to perform a particular function, a data storage medium that stores the program code, multimedia data, and/or user or intermediate data, etc. Thus, a designated domain may refer to hardware component(s) for realizing the technical ideas of the inventive concept, software component(s) controlling or driving the hardware component(s), and/or a physical and/or structural combination of hardware/software component(s).

In this regard, the CPU 100 of FIG. 1 may be a conventionally understood microprocessor. The CPU 100 will be capable of running (or executing) the operations of the electronic device 1 and managing various functions thereof. The CPU 100 may be used to control the operations of the top domain 200, storage domain 300, audio sub-system 400, and/or alive domain 500. As will be understood by those skilled in the art, the CPU 100 will include various memories (e.g., Read-Only-Memory or ROM), registers, data and/or instruction caches, etc., necessary to store and/or execute software/firmware associate with the functionality provided by the audio processing system 20.

Here, the top domain 200 may consist of a group of intellectual properties (IPs) associated with multimedia data encoding/decoding (or codec) and similar functions required by the CPU 100. The top domain 200 may be used to manage the communication (i.e., the reception and/or transmission) of multimedia data between the CPU 100 other components, such as the storage domain 300. The top domain 200 may adaptively gate one or more clock signal(s) applied to respective IPs, or adaptively adjust the frequency of one or more clock signal(s) in response to an indicated function or power mode(s) for the electronic device 1.

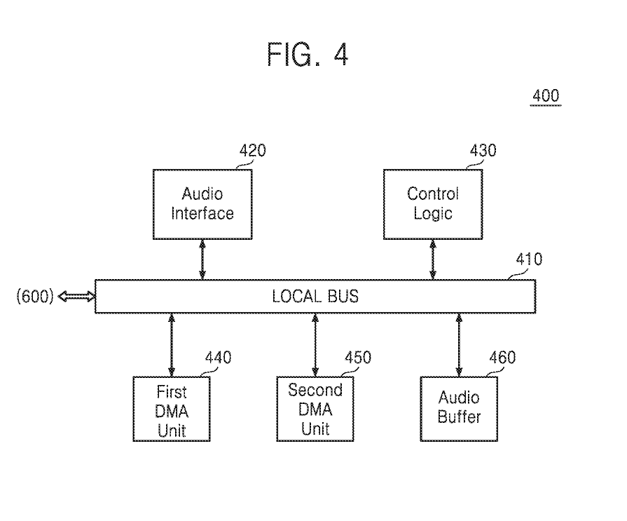

The storage domain 300 may be used to store program code and/or data used by the CPU 100, including multimedia data. Such data, in whole or in part, may be communicated between the storage domain 300 and the top domain 200 or the audio sub-system 400. That is, in certain embodiments of the inventive concept, at least multimedia data stored in the storage domain 300 may be accessed by the top domain 200 or the audio sub-system 400. In this manner, the audio sub-system 400 may receive and temporarily store multimedia data, such as audio data, from the storage domain 300 and thereafter transmit the audio data via an appropriate interface (e.g., audio interface 420 described in relation to FIG. 4) connected to, e.g., the earphone jack 15, speaker 3, and/or microphone 14 shown in FIG. 1.

The so-called alive domain 500 may be used to control the definition and provision of power supply voltages to the respective component(s) of audio processing system 20, such as the CPU 100, top domain 200, storage domain 300, audio sub-system 400, and system bus 600. The alive domain 500 may also be used to facilitate the receipt, storage and/or transmission of input signal(s) or user input data. In certain embodiments of the inventive concept, the alive domain 500 may be always active, so long as main power is applied to the electronic device 1.

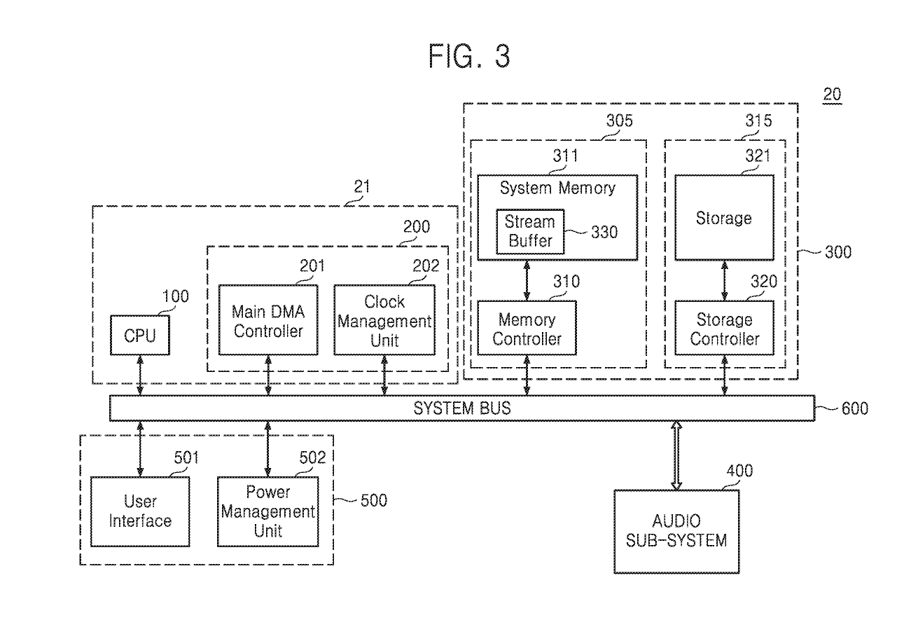

The system bus 600 connects the CPU 100, top domain 200, storage domain 300, and audio sub-system 400 with one another to facilitate the communication of data and related control signals or information. The system bus 600 may include one of more bus(es) complying with advanced microcontroller bus architecture (or AMBA®) in certain embodiments of the inventive concept. The configuration and/or operation of the system bus 600 may change according to specified power mode, e.g., in response to a control signal request issued by the CPU 100 and/or the audio sub-system 400. In certain embodiments of the inventive concept, a power management unit 502 described hereafter in relation to FIG. 3 may be used in this capacity.

While the audio sub-system 400 is accessing and/or buffering audio data during a playback operation, the CPU 100, top domain 200, and storage domain 300 may enter a low power mode in the absence of some of instruction (e.g., receipt of another request). The system bus 600 may also enter a low power mode in the absence of another request until the audio sub-system 400 is ready to provide playback audio data. However, when the audio sub-system 400 requests communication with the CPU 100, at least one of the top domain 200, storage domain 300, and/or alive domain 500, along with the system bus 600 will be activated by the request.

Here, the low power mode is assumed to be a minimum power consumption standby state for receiving one or more control signal(s) from the alive domain 500. The low power mode for a system memory, like the system memory 311 described in relation to FIG. 3, may be a self-refresh operation. In contrast to the low power mode, activation causes one or more components of the audio processing system 20 to transition into a normal power mode, wherein constituent IP(s) operate normally and consume a normal amount of power. Those skilled in the art will understand that the term “normal” in this regard will denote various operative modes and corresponding power consumption profiles. However, for any given IP or collection of IPs, a normal power mode is assumed to be characterized by a power consumption profile greater than the low power mode for the same IP or collection of IPs.

The CPU 100, top domain 200, and audio sub-system 400 may be implemented in separate chips, respectively, or at least two of them may be implemented together in a single chip in certain embodiments of the inventive concept. Alternatively, the CPU 100, top domain 200, and audio sub-system 400 may be implemented in separate integrated circuits (ICs), respectively, or at least two of them may be formed across at least one IC.

FIG. 3 is a block diagram further illustrating in one example the audio processing system 20 of FIG. 2. Referring to FIG. 3, the audio processing system 20 includes a first unit 21—including the CPU 100 and top domain 200, storage domain 300, audio sub-system 400, alive domain 500, and system bus 600.

The CPU 100 may be used to control the top domain 200 and audio sub-system 400 in response to one or more input signal(s) provided by a user or an external device. The CPU 100 may initialize and thereafter control the audio sub-system 400 to playback audio data. In this regard, audio playback (e.g., an audio playback operation or audio playback mode) may be initiated in response to a playback request provided by the alive domain 500. e.g., in response to a user input signal. In addition, upon receiving an end playback request from the alive domain 500. e.g., in response to a user signal provided to a user interface 501, the CPU 100 may control the audio sub-system 400 to halt or interrupt the audio playback.

During the audio playback, the CPU 100 may be used to decode audio data stored in a storage unit 315 of the storage domain 300 in order to generate decoded audio data. The CPU decoding of stored audio data may be performed in conjunction with or in response to various requests from the audio sub-system 400. Once generated by the CPU 100, the decoded audio data may be stored in a system memory 311.

In the illustrated example of FIG. 3, it is assumed that the top domain 200 includes a main direct memory access (DMA) controller 201 and a clock management unit 202. The main DMA controller 201 may directly access audio data stored in the storage unit 315, may communicate the audio data to the CPU 100 via the system bus 600, and may thereafter communicate decoded audio data from the CPU 100 to the storage unit 315. The clock management unit 202 receives at least one power supply signal and clock signal from the alive domain 500, and controls the frequency of the at least one clock signal and/or appropriately gates the at least one clock signal to generate one or more clock signal(s) for the respective IPs.

The top domain 200 of FIG. 3 is shown as including the main DMA controller 201 and clock management unit 202, the embodiments of the inventive concept are not restricted to only this configuration. Those skilled in the art will recognize that the top domain 200 may also include other IPs.

The storage domain 300 illustrated in FIG. 3 includes a system memory unit 305 and the storage unit 315, where the system memory unit 305 includes a memory controller 310 and the system memory 311.

The memory controller 310 may access the system memory 311 to write data to or read data from the system memory 311 at the request of the main DMA controller 201 or the audio sub-system 400. The system memory 311 may include a stream buffer 330 which stores decoded audio data received from the CPU 100.

The system memory 311 may be implemented using volatile memory, such as dynamic random access memory (DRAM), static RAM (SRAM), fast page mode (FPM) DRAM, window RAM (WRAM), extended data out (EDO) RAM, burst EDO (BEDO) RAM, multibank DRAM (MDRAM), synchronous graphics RAM (SGRAM), synchronous DRAM (SDRAM), direct Rambus DRAM (DRDRAM), double data rate (DDR) SDRAM, and pseudo-static RAM (PSRAM).

The storage unit 315 includes a storage controller 320 and a storage 321. The storage controller 320 may be used to control the storage 321 in order to write data to or read data from the storage 321. The storage 321 may be accessed by the main DMA controller 201 in order to communicate multimedia data to the CPU 100 or the system memory 311.

The storage 321 may be implemented using an embedded memory device such as an embedded multimedia card (eMMC), universal flash storage (UFS), or external memory device such as a secure digital (SD) card. The embedded or external memory device may include non-volatile memory, such as flash memory, magnetic RAM (MRAM), resistive RAM (RRAM), phase-change RAM (PRAM), read-only memory (ROM), electrically erasable programmable read-only memory (EEPROM), and resistive memory.

The alive domain 500 illustrated in FIG. 3 includes the user interface 501 and power management unit 502. The user interface 501 may take many different forms but essentially receives various types of input signals, such as touch input, gesture input, temperature input, audio input, camera input, and button input, from a user. In response to one or more of these input signals, the alive domain 500 communicates one or more control signal(s), control data, power signal(s), etc. to one or more of the IPs 100, 200, 300, 400, and 500.

The power management unit 502 may be used to control the definition and provision of one or more power supply signal(s) to the CPU 100, top domain 200, storage domain 300, audio sub-system 400, and system bus 600. In this regard, the power management unit 502 may control each of the CPU 100, top domain 200, storage domain 300, audio sub-system 400, and system bus 600 to independently enter/exit a low power mode. That is, the power management unit 502 may be used to individually activate the CPU 100, top domain 200, storage domain 300, audio sub-system 400, and system bus 600.

FIG. 4 is a block diagram further illustrating in one example the audio sub-system 400 of FIG. 3. Referring collectively to FIGS. 1, 2, 3 and 4, the audio sub-system 400 may include a local bus 410, an audio interface 420, a control logic 430, a first DMA unit 440, a second DMA unit 450, and an audio buffer 460.

The local bus 410 connects the audio interface 420, control logic 430, first DMA unit 440, second DMA unit 450, and audio buffer 460 with one another in a manner independent of the system bus 600. The local bus 410 may also be used to connect the audio sub-system 400 to the system bus 600.

The audio interface 420 may be used to provide audio data stored in the audio buffer 460 to one or more audio output units, such as the earphone jack 15 and speaker 3. The control logic 430 may be used to control the overall operation of the audio sub-system 400. The first DMA unit 440 may directly access the audio buffer 460 and communicate audio data stored in the audio buffer 460 to the audio interface 420 under the control of the CPU 100 and/or control logic 430. In this manner, the first DMA unit 440 manages the communication of data in relation to the audio buffer 460.

The second DMA unit 450 may directly access the system memory unit 305 and communicate audio data stored in the stream buffer 330 to the audio buffer 460 under the control of the CPU 100 and/or control logic 430. In this manner, the second DMA unit 450 manages the communication of data between the system memory unit 305 and audio buffer 460.

The audio buffer 460 may be used to store audio data, and may be read from, or written to by the first DMA unit 440 and/or second DMA unit 450. The audio buffer 460 may be implemented as a dual buffer implemented using SRAM, but the inventive concept is not restricted to only this embodiment.

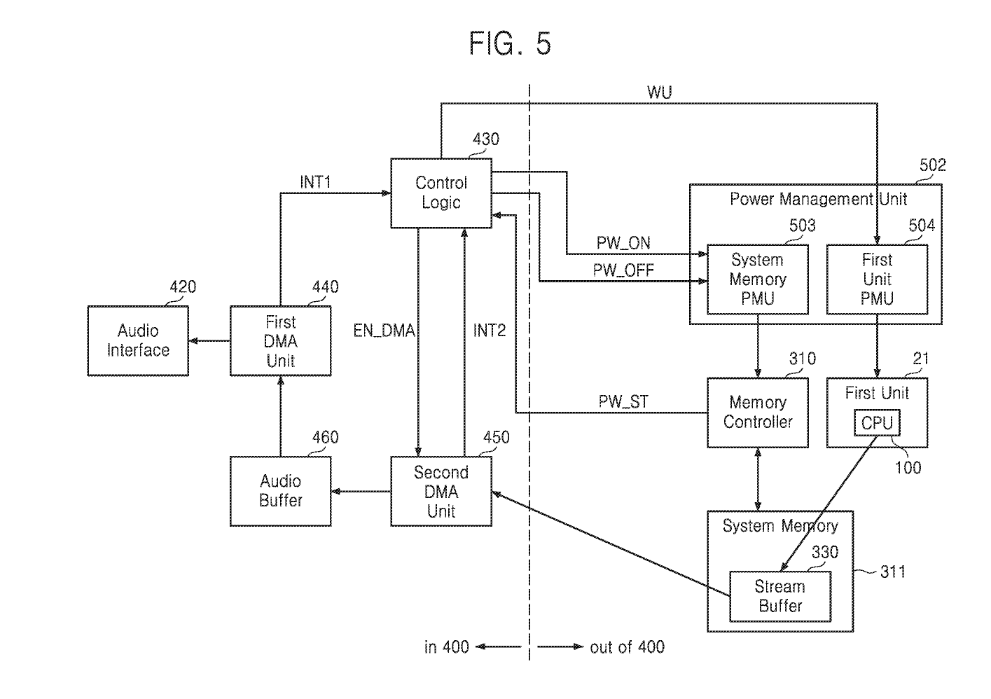

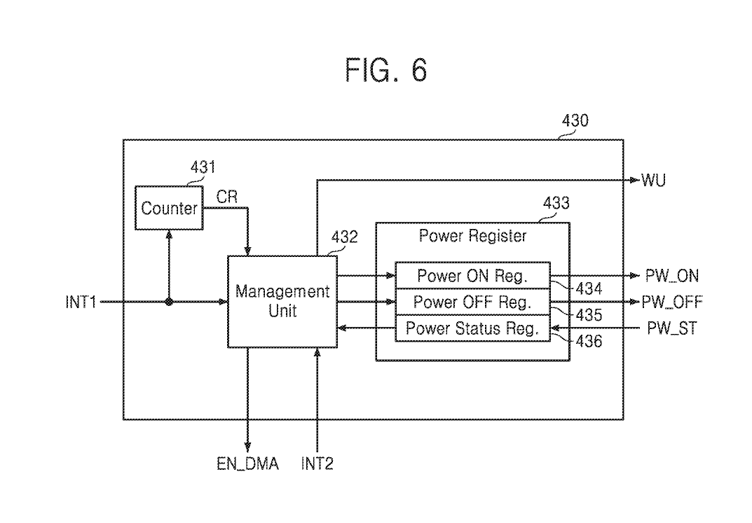

The control logic 430 may be used to control the entering into, or the exit from the low power mode by the first unit 21 and system memory unit 305 in response to a first interrupt signal (e.g., ‘INT1’ described in relation to FIGS. 5 and 6 hereafter) generated when the audio buffer 460 is empty. Further, the control logic 430 may be used to control the entering into or exit from the lower power mode by the system memory unit 305 in response to a second interrupt (e.g., ‘INT2’ described in relation to FIGS. 5 and 6 hereafter) generated when the audio buffer 460 is full. One example of operation for the control logic 430 will be described in some additional detail with reference to FIGS. 5 and 6.

FIG. 5 is a conceptual diagram illustrating one possible mode of operation for the audio sub-system 400 of FIG. 4, and FIG. 6 is a block diagram further illustrating in one example the control logic 430 of FIG. 5.

Referring collectively to FIGS. 1, 2, 3, 4, 5 and 6, when the CPU 100 receives an audio playback request, the CPU 100 decodes audio data corresponding to the request, which has been compressed and stored in the storage 321 or the stream buffer 330, and stores the resulting decoded audio data in the stream buffer 330 or a pulse code modulation (PCM) buffer (not shown). When the audio sub-system 400 is activated, the second DMA unit 450 communicates the decoded audio data from the stream buffer 330 to the audio buffer 460 under the control of the CPU 100. Here, it is assumed that the storage capacity of the audio buffer 460 is about one-quarter that of the stream buffer 330 for purpose of this description.

When the audio buffer 460 is filled with the decoded audio data, the first DMA unit 440 communicates the decoded audio data to the audio interface 420. The first DMA unit 440 may monitor the audio buffer 460 and communicate the first interrupt signal INT1 to the control logic 430 when the audio buffer 460 is empty. Here, the term “monitoring” means determining whether all of the audio data stored in the audio buffer 460 has been transmitted. Assuming that the audio buffer 460 includes 1K (1024) memory cells which respectively have addresses ranging from 0 through 1023, the monitoring function performed by the first DMA unit 440 may simply be an operation of determining when a currently accessed address reaches 1023.

The control logic 430 may include a counter 431, a management unit 432, and a power register 433. The counter 431 may perform a counting operation in response to the first interrupt signal INT1 in order to generate a count value CR. For instance, the counter 431 may initially store a reset value (e.g., ‘0’) of the count value CR, and then generate the count value CR by incrementing the count value by 1 per a given clock cycle upon receipt of the first interrupt signal INT1. In this regard, the counter 431 may be reset under the control of the management unit 432.

The management unit 432 may set a power ON register 434 of the power register 433 in response to the first interrupt signal INT1. For instance, the power ON register 434 may store 1-bit data (i.e., 0 or 1) and setting the power ON register 434 may refer to changing the data that has been reset to 0 in the power ON register 434 into “1”.

Upon receiving the first interrupt signal INT1, the management unit 432 may compare a predetermined count value threshold with the current count value CR received from the counter 431. So long as the count value CR is less than the count value threshold, the management unit 432 will not generate a wake-up signal WU. However, when the count value CR reaches the count value threshold, the management unit 432 generates and communicates the wake-up signal WU to the power management unit 502, and the wake-up signal WU enables the first unit 21 to exit the low power mode. The management unit 432 may reset the counter 431 when it generates the wake-up signal WU.

Here, that the management unit 432 does not generate the wake-up signal WU upon each reception of the first interrupt signal INT1, but instead generates the wake-up signal WU only when the count value CR has reached count value threshold. However, this approach in just one example of a control method that may be used to generate the wake-up signal WU. In this regard, the scope of the inventive concept contemplate may different modes of operation for the management unit 432 in the generation of the wake-up signal WU through separate logic instead of immediately generating the wake-up signal WU upon each reception of the first interrupt signal INT1. Furthermore, the audio sub-system 400 may monitor the audio buffer 460, which temporarily stores the decoded audio data, in order to determine the entering into or the exit from the low power mode for the first unit 21 and/or the system memory unit 305.

In view of the foregoing, a particular count value threshold may be determined by the size of the audio buffer 460, the size of the stream buffer 330, one or more system policies controlling audio playback, and/or the timing control (e.g., time tick) of the CPU 100. For instance, when the size of the audio buffer 460 is a quarter of the size of the stream buffer 330, the stream buffer 330 is emptied after the audio buffer 460 becomes full four (4) times and decoding needs to be performed by the CPU 100. As a result, the count value threshold may be set to a maximum of 3, whereupon the counter 431 will be reset to 0. Thus, the use of a particular count value threshold is a matter of design choice.

The management unit 432 may generate a DMA enable signal EN_DMA when a power status register 436 of the power register 433 is set. The management unit 432 may also set a power OFF register 435 of the power register 433 in response to the second interrupt signal INT2.

The power register 433 may include a power ON register 434, a power OFF register 435, and a power status register 436. The power ON register 434 may be set or reset by the management unit 432. When the power ON register 434 is set, the power ON register 434 may generate a power ON signal PW_ON that enables the system memory unit 305 to exit the low power mode. The power OFF register 435 may be set or reset by the management unit 432. When the power OFF register 435 is set, the power OFF register 435 may generate a power OFF signal PW_OFF allowing the system memory unit 305 to enter the low power mode. Here, the power ON signal PW_ON and the power OFF signal PW_OFF need not be special signals, but may indicate that the power management unit 502 can directly check values respectively stored in the power ON register 434 and the power OFF register 435.

The power status register 436 may be set or reset by a power status signal PW_ST provided by the memory controller 310. Whether the power status register 436 is set or not may be monitored by the management unit 432.

Referring back to FIG. 5, upon receiving the first interrupt signal INT1, the control logic 430 may generate and communicate the power ON signal PW_ON to a system memory power management unit (PMU) 503 of the power management unit 502. The system memory PMU 503 manages the definition and/or provision of one or more power supply signals to the memory controller 310 and the system memory 311. The system memory PMU 503 may activate (i.e., exit the low power mode) the memory controller 310 and the system memory 311, or deactivate (i.e., enter the low power mode) the memory controller 310 and the system memory 311. Upon receiving the power ON signal PW_ON, the system memory PMU 503 may activate the memory controller 310 and the system memory 311.

When the memory controller 310 and the system memory 311 are fully activated, the memory controller 310 may generate the power status signal PW_ST. The control logic 430 may generate the DMA enable signal EN_DMA in response to the power status signal PW_ST. Upon receiving the DMA enable signal EN_DMA, the second DMA unit 450 may access the stream buffer 330 of the system memory 311 that has been activated and “move” decoded audio data to the audio buffer 460. In this context, those skilled in the art understand the conventional operation of DMA units in moving data from one point to another in a digital logic system.

The second DMA unit 450 may monitor the audio buffer 460 and may generate the second interrupt signal INT2 to the control logic 430 when the audio buffer 460 is filled with decoded audio data. Upon receiving the second interrupt signal INT2, the control logic 430 may generate the power OFF signal PW_OFF to the system memory PMU 503. Upon receiving the power OFF signal PW_OFF, the system memory PMU 503 allows the memory controller 310 and the system memory 311 to enter the low power mode.

However, while the first unit 21 is being activated by a first unit PMU 504, the system memory PMU 503 does not allow the memory controller 310 and the system memory 311 to enter the low power mode even if it receives the power OFF signal PW_OFF. Alternatively, the control logic 430 may set and reset the power OFF register 435 so that the memory controller 310 and the system memory 311 do not enter the low power mode while the first unit 21 is being activated even if it receives the second interrupt signal INT2. This is because it is likely that the CPU 100 is performing audio data decoding and storing in the stream buffer 330 although transmission of audio data from the stream buffer 330 to the audio buffer 460 has been completed.

The control logic 430 receives the first interrupt signal INT1 and generates the wake-up signal WU when the count value CR reaches the count value threshold.

The first unit PMU 504 of the power management unit 502 manages power supply to the first unit 21. The first unit PMU 504 may activate the first unit 21 or allow the first unit 21 to enter the low power mode. Upon receiving the wake-up signal WU, the first unit PMU 504 may exit the low power mode.

An activated CPU 100 may decode audio data and communicate the decoded audio data to the stream buffer 330. The CPU 100 may monitor whether the stream buffer 330 has been filled with audio data. When the stream buffer 330 has been filled with audio data, the CPU 100 may inform the first unit PMU 504 of the completion of decoding and may enter the low power mode under the control of the first unit PMU 504.

In the embodiments illustrated in FIG. 6, the management unit 432 may request exit from the low power mode of the system memory unit 305 using the power register 433, access the stream buffer 330 of the system memory 311 to bring decoded audio data to the audio buffer 460, and then make a request that allows the system memory unit 305 to enter the low power mode. However, the scope of the inventive concept is not restricted to only this particular approach. The management unit 432 may selectively request the entry into, or exit from the low power mode for the system memory unit 305 in response to the first and/or second interrupt signals INT1 and INT2 using different approaches and may control the communication of decoded audio data from the stream buffer 330 to the audio buffer 460 when the system memory unit 305 exits the low power mode.

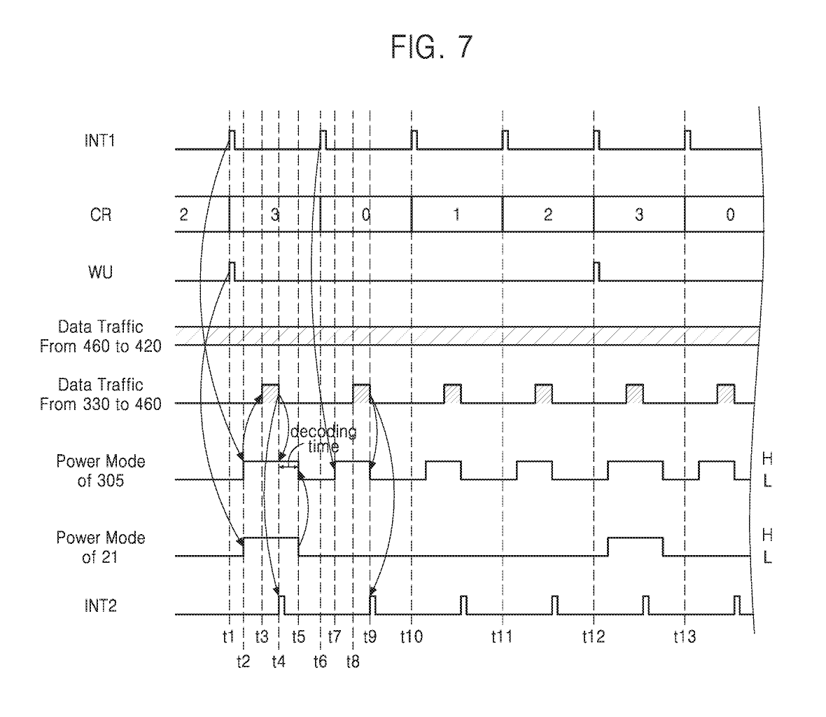

FIG. 7 is a timing chart further illustrating the operation of the audio processing system 20 illustrated in FIG. 2. Operations performed during the audio playback by the audio processing system 20 will be described with reference to FIGS. 1, 2, 3, 4, 5, 6 and 7. Since the audio playback is performed in a continuous manner, corresponding audio data must be seamlessly communicated from the audio buffer 460 to the audio interface 420, such no gaps or interruptions in the user's audio experience are generated. Accordingly, the audio buffer 460 is implemented as a dual buffer so that even when one buffer is emptied and the first interrupt signal INT1 is generated, decoded audio data may be continuously provided to the audio interface 420 via the other buffer. In FIG. 7, cross-hatched portions of the data traffic signal between the audio buffer 460 and audio interface 420, and between the stream buffer 330 and the audio buffer 460 denote periods during which decoded audio data provision is performed.

As the audio buffer 460 is emptied at time t1, the first interrupt signal INT1 and the power ON signal PW_ON are generated, so that the power management unit 502 requests activation of the system memory unit 305. As the first interrupt signal INT1 is generated, the counter 431 increases a previous count value CR (assumed to be “2”) by 1, thereby outputting “3” as a new count value CR. Since the predetermined count value threshold (assumed to be “3”) is the same as the count value CR, the management unit 432 generates the wake-up signal WU at a high level and the power management unit 502 requests activation of the first unit 21.

The activation of the first unit 21 and the system memory unit 305 is completed and the low power mode is exited at time t2. In FIG. 7, high level H of the power mode of the system memory unit 305 and the power mode of the first unit 21 indicates that each of the IPs 21 and 305 has been activated, i.e., has exited from the low power mode; low level L thereof indicates that each of the IPs 21 and 305 has been deactivated, i.e., has entered the low power mode. As the activation of the system memory unit 305 is completed, the power status signal PW_ST is generated.

The DMA enable signal EN_DMA is generated according to the power status signal PW_ST and audio data transmission from the stream buffer 330 to the audio buffer 460 starts at time t3.

The decoded audio data transmission from the stream buffer 330 to the audio buffer 460 is completed and the second interrupt signal INT2 is generated at time t4. In addition, the CPU 100 decodes audio data and transmits the decoded audio data to the stream buffer 330. Accordingly, the power OFF signal PW_OFF is generated according to the second interrupt signal INT2, but the power management unit 502 may not allow the system memory unit 305 to enter the low power mode since the first unit 21 is still in an active state.

At time t5, the CPU 100 completes the decoding of audio data and enters the low power mode, and the power management unit 502 allows the system memory unit 305 to enter the low power mode since the first unit 21 has entered the low power mode. In other words, even if the second interrupt signal INT2 is generated, the system memory unit 305 is not allowed to enter the low power mode during the audio data decoding operations of the CPU 100.

At time t6, the first interrupt signal INT1 and the power ON signal PW_ON are generated as the audio buffer 460 is emptied and the power management unit 502 requests activation of the system memory unit 305. As the first interrupt signal INT1 is generated, the control logic 430 resets the count value CR of the counter 431 to “0”. Therefore, the control logic 430 does not generate the wake-up signal WU and the power management unit 502 does not request activation of the first unit 21. As a result, the first unit 21 remains in the low power mode.

At time t7, the activation of the system memory unit 305 is completed and may exit from the low power mode. With the completion of the activation of the system memory unit 305, the power status signal PW_ST is generated.

At time t8, the DMA enable signal EN_DMA is generated according to the power status signal PW_ST and transmission of audio data from the stream buffer 330 to the audio buffer 460 begins.

At time t9, the transmission of audio data from the stream buffer 330 to the audio buffer 460 is complete and the second interrupt signal INT2 is generated. The power OFF signal PW_OFF is generated according to the second interrupt signal INT2 and the power management unit 502 immediately allows the system memory unit 305 to enter the low power mode. In other words, unlike at time t4, the first unit 21 is not in the active state, and therefore, the power management unit 502 immediately allows the system memory unit 305 to enter the low power mode.

Thereafter, the first interrupt signal INT1 is repeatedly generated at time t10, t11, t12, and t13, but the wake-up signal WU is generated only in periods between the times t12 and t13 in which the count value CR is 3, so that the first unit 21 may exit the low power mode. Power consumed to activate the first unit 21 is several times greater than power consumed to activate the system memory unit 305.

According to embodiments of the inventive concept, the audio processing system 20 does not activate the first unit 21—which consumes a relatively high level of power—during the entirety of the audio playback, but instead activates the first unit 21 during a minimum number of time periods, thereby reducing overall power consumption. In other words, the audio processing system 20 does not always activate the CPU 100 when the audio buffer 460 is emptied but selectively activates the CPU 100 using special logic only when activation of the CPU 100 is necessary, thereby notably reducing power consumption. In particular, even when a processor is not included in the audio sub-system 400 for a design purpose, power consumption can be greatly reduced using this approach.

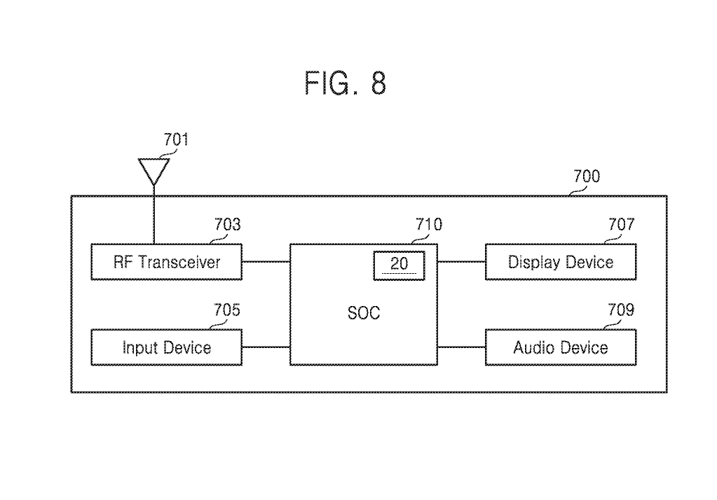

FIG. 8 is a block diagram of an electronic system 700 including the audio processing system 20 according to some embodiments of the inventive concept. Referring to FIGS. 2 and 8, the electronic system 700 includes a system on chip (SoC) 710 including the audio processing system 20, an antenna 701, a radio frequency (RF) transceiver 703, an input device 705, a display device 707, and an audio device 709.

The audio processing system 20 illustrated in FIG. 2 may be implemented in the SoC 710. The SoC 710 may be manufactured as a single chip and packaged into a single package. The electronic system 700 including the SoC 710 may be implemented as a personal computer (PC), a network server, a tablet PC, a net-book, an e-reader, a personal digital assistant (PDA), a portable multimedia player (PMP), an MP3 player, or an MP4 player.

The RF transceiver 703 may transmit and receive RF signals through the antenna 701. The RF transceiver 703 may convert an RF signal received through the antenna 701 into a signal that can be processed by the SoC 710. The SoC 710 may process the signal output from the RF transceiver 703 and transmit the processed signal to the display device 707. The RF transceiver 703 may also convert a signal output from the SoC 710 into an RF signal and output the RF signal to an external device through the antenna 701.

The input device 705 allows control signals for controlling the operation of the SoC 710 or data to be processed by the SoC 710 to be input to the electronic system 700. The input device 705 may be implemented as a pointing device such as a touch pad or a computer mouse, a keypad, or a keyboard.

The audio device 709 is used by the audio interface 420 in the SoC 710 to output audio data. The audio device 709 may be implemented as a speaker or an output device to which an earphone is connected.

As described above, according to embodiments of the inventive concept, an audio processing system does not allow a first unit, which includes a CPU and a top domain consuming a relatively high level of power, to be continuously active during audio playback but selectively activates the first unit using special logic only when necessary, thereby significantly reducing power consumption.

While the inventive concept has been particularly shown and described with reference to exemplary embodiments thereof, it will be understood by those of ordinary skill in the art that various changes in forms and details may be made therein without departing from the scope of the inventive concept as defined by the following claims.

What is claimed is:

1. An audio processing system comprising:
a storage domain including a system memory unit;
a first unit including a central processing unit (CPU) and a top domain, wherein the CPU decodes audio data stored in the storage domain to generate decoded audio data that is stored in the system memory unit;
a power management unit configured to provide at least one power supply signal to the first unit and the system memory unit; and
an audio sub-system including;
an audio buffer that stores decoded audio data received from the system memory unit,
a first Direct Memory Access (DMA) unit that moves decoded audio data from the audio buffer to an audio interface, wherein the first DMA unit generates a first interrupt signal when the audio buffer is emptied, and
a control logic that determines when the first unit exits a low power mode.

2. The audio processing system of claim 1, wherein the control logic includes a counter generating a count value, and the first unit exits the low power mode only when the count value reaches a predetermined count value threshold.

3. The audio processing system of claim 2, wherein the counter resets the count value in response to the first interrupt signal.

4. The audio processing system of claim 1, wherein the control logic generates a power ON signal, and the power management unit enables the system memory unit to exit the low power mode in response to the first interrupt signal and the power ON signal.

5. The audio processing system of claim 2, wherein the audio sub-system further comprises a second DMA unit that moves the decoded audio data from the system memory unit to the audio buffer and generates a second interrupt signal when the audio buffer is filled.

6. The audio processing system of claim 5, wherein the control logic generates a power OFF signal, and the power management unit enables the system memory unit to enter the low power mode in response to the second interrupt signal and the power OFF signal.

7. The audio processing system of claim 5, wherein the power management unit enables the system memory unit to exit the low power mode only when the first unit has not entered the low power mode regardless of the power OFF signal.

8. The audio processing system of claim 5, wherein the control logic further includes;
a management unit that generates a wake-up signal causing the first unit to exit the low power mode when the count value reaches the count value threshold; and
a power register that generates the power ON signal enabling the system memory unit to exit the low power mode when the first interrupt signal is generated, and the power OFF signal that enables the system memory unit to enter the low power mode when the second interrupt signal is generated.

9. An audio processing system configured to operate in a playback mode, the audio processing system comprising:
a storage domain including a system memory unit that stores audio data, and is selectively configured to operate in a low power mode and a normal power mode;
a first unit including a central processing unit (CPU) and a top domain, wherein the CPU decode the audio data to generate decoded audio data, and the CPU is selectively configured to operate in the low power mode and the normal power mode;
an alive domain including a power management unit that provides at least one power supply signal to the first unit and the system memory unit in response to a user input signal indicating operation of the audio processing system in the playback mode; and
an audio sub-system including;
an audio buffer that stores decoded audio data,
a first Direct Memory Access (DMA) unit that moves decoded audio data from the audio buffer to an audio interface, wherein the first DMA unit generates a first interrupt signal when the audio buffer is emptied, and
a control logic that determines when the CPU operates in the low power mode.

10. The audio processing system of claim 9, wherein the audio sub-system further comprises a second DMA unit that moves decoded audio data from the system memory unit to the audio buffer and generates a second interrupt signal when the audio buffer is filled.

11. The audio processing system of claim 9, wherein the control logic includes a counter generating a count value, and the CPU exits the low power mode only when the count value reaches a predetermined count value threshold.

12. The audio processing system of claim 11, wherein the counter resets the count value in response to the first interrupt signal.

13. The audio processing system of claim 12, wherein the control logic generates a power ON signal and the power management unit enables the system memory unit to exit the low power mode in response to the first interrupt signal and the power ON signal.

14. The audio processing system of claim 13, wherein the control logic generates a power OFF signal, and the power management unit enables the system memory unit to enter the low power mode in response to the second interrupt signal and the power OFF signal.

15. The audio processing system of claim 14, wherein the control logic further includes;
a management unit that generates a wake-up signal causing the CPU to exit the low power mode when the count value reaches the count value threshold; and
a power register that generates the power ON signal enabling the system memory unit to exit the low power mode when the first interrupt signal is generated, and generates the power OFF signal that enables the system memory unit to enter the low power mode when the second interrupt signal is generated.

16. A method of operating an audio processing system, comprising:
emptying decoded audio data from an audio buffer to an audio interface;
generating a first interrupt signal and a power ON signal in response to the emptying of the audio buffer;
activating a system memory unit storing decoded audio data in response to the power ON signal;
incrementing a count value in response to the first interrupt signal;
generating a wake-up signal when the count value reaches a count value threshold;
activating a Central Processing Unit (CPU) to decode audio data to generate decoded audio data; and
storing the decoded audio data in a stream buffer.

17. The method of claim 16, further comprising:
communicating decoded audio data from the stream buffer to the audio buffer;
upon filling the audio buffer with decoded audio data, generating a second interrupt signal;
enabling the system memory unit to exit a low power mode in response to the second interrupt signal and only if the CPU remains activated.

18. The method of claim 17, further comprising:
causing the CPU to enter the low power mode following decoding of the audio data; and thereafter,
enabling the system memory unit to enter the low power mode.

19. The method of claim 18, further comprising:
generating the first interrupt signal and the power ON signal once the audio buffer is emptied and again activating the system memory unit;
again resetting the count value in response to the first interrupt signal;
upon activation of the system memory unit, generating a power status signal; and
enabling DMA transfer of decoded audio data from the stream buffer to the audio buffer in response to the power status signal.

20. The method of claim 19, further comprising:
again generating the second interrupt signal once the decoded audio signal is transferred from the stream buffer to the audio buffer;
generating a power OFF signal in response to the second interrupt signal, and immediately enabling the system memory unit to enter the low power mode, if the CPU is not in the active state.
